(19) United States
(12) Patent Application Publication
(10) Pub. No.: US 2019/0116169 A1
(43) Pub. Date: Apr. 18, 2019

(54) REAL-TIME DATA FOR ACCESS CONTROL APPROVAL

(71) Applicant: MICROSOFT TECHNOLOGY LICENSING, LLC., Redmond, WA (US)

(72) Inventors: SERGEI BOLOTOV, VANCOUVER (CA); ELIZABETH BROWN, WOODINVILLE, WA (US); ROMAN KHRESTEK, VANCOUVER (CA); ANDREW RYAN PICKERING, WOODINVILLE, WA (US); SAMIR VASANTBHAI SHAH, BELLEVUE, WA (US); JIONG WANG, SEATTLE, WA (US)

(21) Appl. No.: 15/786,887

(22) Filed: Oct. 18, 2017

(51) Int. Cl. H04L 29/06; G06F 21/60; G06F 21/45

(52) U.S. Cl. CPC H04L 63/08; H04L 63/0428; H04L 9/32; G06F 21/45; H04L 63/10; G06F 21/604

(57) ABSTRACT

An approval service is provided that provides an approver, that controls a secured resource, real-time data that verifies the identity of a user or approvee who is seeking access to the secured resource. In one aspect, the real-time data may be an image of the approvee at the time of the request along with geo-coordinates of the location of the approvee when the request is made. In another aspect, the real-time data includes a video communications session that enables the approvee to interact dynamically with the approver to make the request.

### BACKGROUND

Computer security often relies on an access control procedure to control which users are allowed access to a secured resource. Often, the access control procedure requests approval, which can be granted or denied, by a system administrator, individual, and/or system. The approval may be granted using an authentication method that verifies the identity of the user and provides access based on a capability associated with the user and/or secured resource. These authentication methods may utilize passwords, tokens, biometric screening, encryption keys, etc. which are used in a single sign-on operation that does not interact dynamically with the approver.

### SUMMARY

This Summary is provided to introduce a selection of concepts in a simplified form that are further described below in the Detailed Description. This Summary is not intended to identify key features or essential features of the claimed subject matter, nor is it intended to be used to limit the scope of the claimed subject matter.

An approval service provides a central mechanism for a user to initiate approval requests for one or more secured resources with real-time data. The user registers with the approval service and provides identifying data of those parties or approvers needed to consent to the user's access to a secured resource. The approval service generates an approval request that includes real-time data that provides the approver with a more secure identification of the approvee. In one aspect, the real-time data may be an image of the approvee at the time of the request along with geo-coordinates of the location of the approvee when the request is made. In another aspect, the real-time data includes a video communications interface that enables the approvee to interact dynamically with the approver to make the request.

These and other features and advantages will be apparent from a reading of the following detailed description and a review of the associated drawings. It is to be understood that both the foregoing general description and the following detailed description are explanatory only and are not restrictive of aspects as claimed.

### BRIEF DESCRIPTION OF DRAWINGS

FIG. 1 illustrates an exemplary system for facilitating real-time data for access control approval.

FIG. 2 is a flow diagram illustrating an exemplary method for processing an approval request including real-time data.

FIG. 3 is a flow diagram illustrating an exemplary method for processing an access control request.

### DETAILED DESCRIPTION

Overview

An approval service enables a user of a computing device (i.e., approvee) to provide real-time data to an approver to obtain approval or consent which is needed to access a secured resource. A secured resource is any type of information that is available for retrieval by a user of a computing device that requires approval from another source. In one aspect, the approval service sends an approver a request that includes a secured package including a photo taken of the approvee at the time the request is made with the approvee's unique identifier. The approvee's unique identifier may include real-time location coordinates of the approvee's device at the time the request is made. In this manner, the approver is provided with real-time data that securely identifies the approvee. In another aspect, the approval services initiates a video communication session between the approvee and the approver for the approvee to actively engage with the approver for the approval. In either aspect, the approver either grants or denies the request with assurances that the request is from the genuine approvee.

In order to initiate the approval service, an approvee registers with the approval service and designates the approvers needed to consent to access a secured resource. The approval service keeps track of the various approvers and the approvals needed for each of the secured resources that may be consumed by the approvee. In this manner, the approval service can accommodate any approval request of the approvee from a central service.

Attention now turns to a further discussion of the system, devices, components, and methods utilized in the approval service.

Real-Time Approval System

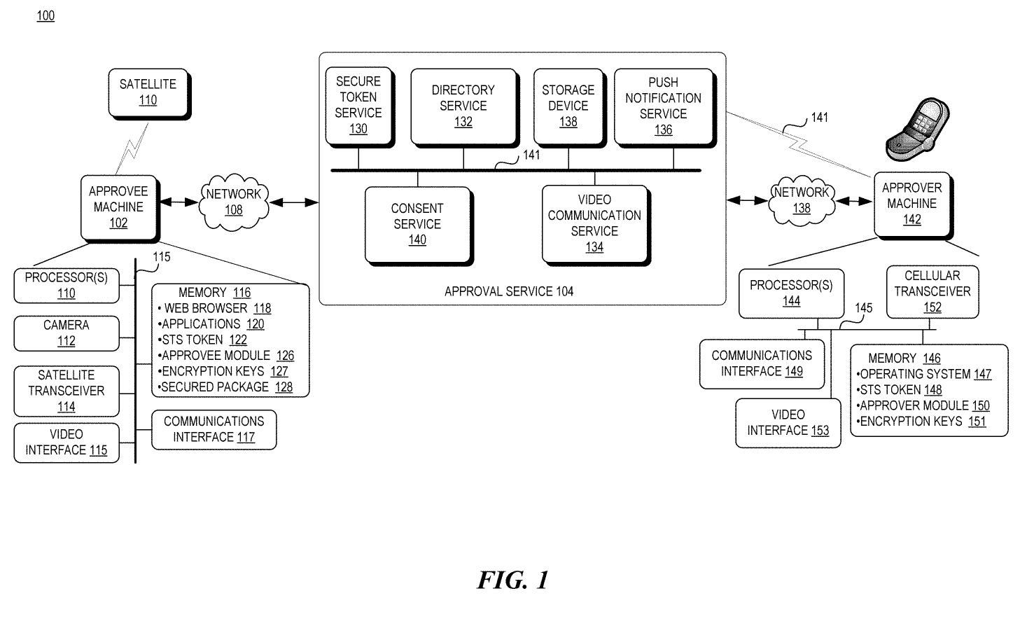

FIG. 1 illustrates a block diagram of an exemplary real-time approval system 100 in which various aspects of the invention may be practiced. As shown in FIG. 1, system 100 includes an approvee machine 102, an approval service 104, and an approver machine 106. The approvee machine 102 is a computing device that is associated with a user or approvee that requires access to a resource that requires the consent of an approver. The approver machine 106 is a computing device that is associated with the approver who has control of the secured resource and the authority to consent to the request. The approval service 104 provides a mechanism that processes the approval request in a manner that can more readily identify an approvee.

The approvee machine 102 is any type of computing device that is communicatively coupled to network 108 that enables communication between the approvee machine 102 and the approval service 104. Network 108 may include any wired or wireless technology, and/or combination thereof, that enables communication between the approvee machine 102 and the approval service 104. The approvee machine 102 is also communicatively coupled to a satellite positioning system 110, such as the Global Positioning System (GPS), which enables the approvee machine 102 to generate the geographical coordinates that represent the location of the approvee machine 102 at the time of an approval request.

The approvee machine 102 may include at least one processor 110, a camera 112, a satellite transceiver 114, a video interface 115, a memory 116, and a communications interface 117. The memory 116 may include a web browser 118, one or more applications 120, a service transaction service (STS) token 122, an approval module 126, an encryption key pair 127, and a secure package 128. The web browser 118 enables the approvee to access resources on the Internet that may require some type of approval. The applications 120 may include programs, such as video games, that may require some type of approval. The STS token 122 is used to verify the identity of the approvee with the approval service 104 and which is provided to the approvee when the approvee registers with the approval service 104.

The approvee module 126 is a software program having executable instructions that enables the approvee's machine 102 to interact with the approval service 104. The approvee module 126 is provided by the approval service 104 and may be implemented as plug-in or add-in to the operating system of the approvee's machine 102. The approvee module 126 includes a user interface that guides the user in formulating an approval request for submission to the approval service 104. In the case where the approval request includes a secured package 128, the approvee module 126 obtains the requisite contents for the secured package. The user interface of the approval module also visually displays the response from the approver.

The encryption keys 127 include a public and private key pair that are used to encrypt and decrypt data, such as the secured package. The public key is shared with the approver and the private key is used by the approvee. Either of the keys can be used to encrypt the secured package with the opposite one of the pair used to decrypt the secured package.

The approval service 104 can be configured as a network service or cloud service that interacts with the approvee and approver. The approval service 104 can be implemented in a single computing device or composed of multiple computing devices connected through a network. The approval service 104 may include a security token service (STS) 130, a directory service 132, a video communication service 134, a push notification service 136, a storage device 138, and a consent service 140. The STS 130 is a web service that issues security tokens that are used to authenticate or verify a user when the user interacts with the approval service 104. The STS 130 employs various protocols, methods and technologies that adhere to a trust specification, such as without limitation, the WS-Trust specification, Microsoft's Access Control Services, OpenID, and the like.

The directory service 132 stores the relationships between an approvee and an approver for a resource. A relationship pairs an approvee with one or more approvers for a particular resource. The directory service 132 can be implemented as a database, table, or other configuration of a collection of data. The directory service 132 can include for each approvee and approver an identity, such as an email address, logon name to the service, cell phone number, and/or IP address and the resource needing approval from an approver.

The video communication service 134 is used to transmit a real-time interactive video communication session (e.g., video teleconference) from the approvee's machine 102 to the approver's machine 106. The real-time interactive video communication session is a semi-permanent bi-directional transmission of content, information and/or data between the approvee's machine 102 and the approver's machine 106 over a communication network. The real-time interactive video communication session may include video, audio, text, and/or images, and combinations thereof. The real-time interactive video communication sessions may employ various methods and technologies, such as without limitation, Voice Over Internet Protocol (VoIP) and may include audio and video teleconferencing through commercial products, such as SKYPE™, FACETIME™, GOTOMEETING™, HANGOUTS™, and the like.

The push notification service 136 is a push-based technology that initiates a notification to the approver when an approval request is initiated. The approver subscribes to a channel provided by the push notification service 136. A channel is a unique address that represents a single user on a single device for a specific application. For example, a channel can be a Uniform Resource Identifier that is dedicated to the approver. Whenever content is available on the channel, the push notification service 136 pushes the content to the approver. The push notification service 136 may employ various methods and technologies, such as without limitation, Webpush, HTTP server push, Google Cloud Messaging, Apple Push Notification Service, long polling, Short Message Service, Windows Push Notification Service, and the like.

The consent service 140 controls the operation of the approval service 104. The consent service 140 receives a verified approval request from the STS 130 and transfers the request to the appropriate approver. The consent service 140 engages with the approvee module 126 to generate the secured package 128 which is then transmitted to the approver through the push notification service 136. Alternatively, the consent service 140 initiates the video communication service 134 to facilitate communications between the approvee and approver.

The approver machine 142 is a computing device that may include at least one processor 144, a memory 146, a communications interface 149 and a video interface 153. In at least one aspect, the approver machine 142 is a cellular mobile device that receives and transmits cellular signals 141 using a cellular transceiver 152. The approver machine 142 is connected to network 138 that may include any wired or wireless technology, and/or combination thereof, that enables communication between the approver machine 142 and the approval service 104. The memory 146 may include a STS token 148, an approver module 150, and encryption keys 151. The STS token 148 is used to verify the identity of the approver during communications with the approval service 104 and is provided to the approvee when the approvee registers with the approval service 104. The approver module 150 contains executable program instructions that enable the device 142 to interact with the approval service 104. The encryption keys 151 include a public and private key pair that enable the approver to decrypt the contents of the secured package.

The approvee machine 102, approval service 104, and approver machine 106 is described in further detail below. It should be noted that FIG. 1 shows components of the system in one aspect of an environment in which various aspects of the invention may be practiced. However, the exact configuration of the components shown in FIG. 1 may not be required to practice the various aspects and variations in the configuration shown in FIG. 1 and the type of components may be made without departing from the spirit or scope of the invention.

Attention now turns to description of the various exemplary methods that utilize the system and device disclosed herein. Operations for the aspects may be further described with reference to various exemplary methods. It may be appreciated that the representative methods do not necessarily have to be executed in the order presented, or in any particular order, unless otherwise indicated. Moreover, various activities described with respect to the methods can be executed in serial or parallel fashion, or any combination of serial and parallel operations. In one or more aspects, the method illustrates operations for the systems and devices disclosed herein.

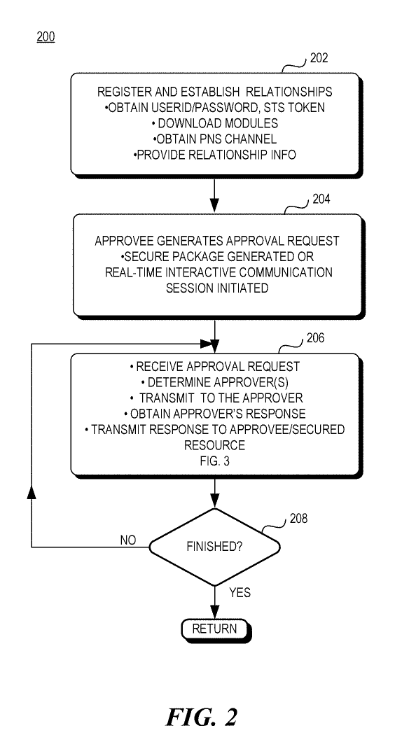

Turning to FIG. 2, the approvee and the approver register with the approval service and establish the approvee and approver relationships (block 202). In one aspect, the approvee and the approver register with the secure token service 130 and receive respective STS tokens that are unique to the registered party (block 202). The STS tokens are used to authenticate the identity of parties that interact with the approval service 104 (block 202). During the registration process, the approvee and approver establish userids and passwords for use with the approval service 104 (block 202). In addition, the approvee and the approver, individually provide additional identifying information such as, without limitation, their respective userids with the approval service 104, email addresses, cell phone numbers, and/or a secret that is shared between the related parties (block 202). This identifying information is used by the approval service 104 to facilitate the communications sessions between the related parties (block 202).

Furthermore, the approval service 104 provides the approvee and the approver, a respective module, either an approvee module 126 or an approver module 150 (block 202). These modules can be loaded into a respective machine as an add-in, plug-in, or by any means in which additional software can be added to an existing program (block 202). In addition, the approval service 104 provides the approver with a PNS channel which is used to push notifications to the approver (block 202).

Once the parties are registered, the approvee provides the approval service 104 with relationship information which includes the identity of the approver or approvers needed to approve a secured resource (block 202). The relationship information is stored with the directory service 132 (block 202). For example, in the case of a child seeking approval from a parent to buy game purchases related to a video game, the child provides to the approval service, the identity of one or more parents that need to approve the purchase and the identity of the application requiring the approval (block 202). This relationship information is stored in the directory service 132 (block 202).

In one aspect, the approvee generates an approval request that includes a secured package 128 (block 204). The approvee module 126 includes a user interface that assists the approvee in preparing the contents needed for the secured package (block 204). The user interface enables the approvee to take a self-photo or image of the approvee at the time the request is initiated (block 204). The approvee module 126 obtains the real-time geographic coordinates of the approvee's machine from the satellite transceiver in the approvee's machine (block 204). Alternatively, the approvee module 126 can utilize the secret that is shared between the related parties instead of the real-time geographic coordinates. The secret can be any data agreed upon by the parties, such as without limitation, the phone model of a party, the phone model number of a party, and so forth. The approvee module 126 formats the secure package and encrypts the secure package with the approvee's private key (block 204). The approvee module 126 then transmits the secured package to the approval service as the approval request (block 204).

Alternatively, the approvee may request a video communication session with the approver (block 204). In this case, the approvee module 126 obtains the current IP address of the approvee machine 102 and initiates an approval request with the approval service 104 indicating that a video communication session is warranted (block 204). The approval request includes at least the STS token 122 and the current IP address of the approvee machine 102 (block 204).

The STS service 130 receives the approval request (block 206). When the approval request is received, the STS service verifies the approvee and notifies the consent service (block 206). The consent service utilizes the dictionary service to determine the appropriate approvers (block 206). The consent service initiates the requisite processes to establish communication with the approver in the manner specified (block 206). In the case of the approval request including the secured package, the push notification service 136 is engaged to push the secured package to the approver (block 206). In the case where the approval request indicates a video communication session, the consent service engages the video communication service 134 to establish the video teleconference (block 206).

Upon notification of the approval request, the approver either grants or denies the request and the response is provided back to the approvee and/or the secured resource (block 206). This process repeats for each approval request (block 208—no) until the approval service is finished (block 208—yes).

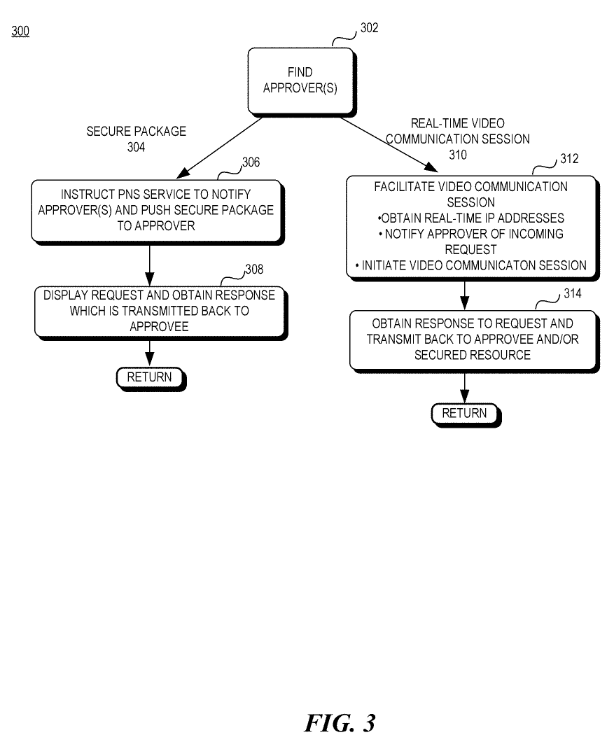

FIG. 3 illustrates an exemplary method further detailing the actions of the approval service in processing an approval request. Upon receipt of the approval request, the consent service 140 finds the approver(s) needed to approve the approval request (block 302). In the case where the approval request includes a secured package 304, the consent service 140 notifies the push notification service to push the secured package 304 to each of the approvers' machine (block 306). The approver module 150 in the approver's machine 142 receives the notification and displays in a user interface the photo of the approvee, the GPS coordinates of the approvee's machine at the time the request was made and the request for the resource (block 308). The user interface also displays a user input element, such as a response button, icon, or the like, for the approver to approve or reject the request (block 308). The approver module 150 accepts the response and transmits the response back to the approval service 104 (block 308). The consent service 140 receives the response and transmits the response to the approvee module 126 which displays the response onto the approvee's machine 102 (block 308).

In the case where the approval request indicates a real-time video communication session 310, the consent service 140 engages the video communication service 134 to setup the video communication session between the approvee's machine 102 and the approver's machine 142 (block 312). The video communication service 134 engages the approver module 150 to obtain the current IP address of the approver machine 142 (block 312). The IP address of the approvee's machine 102 is included in the approval request transmitted to the approval service.

The video communication service 134 then sets up a VoIP session between these machines for the approvee to interactively request the approval for the resource with the approver (block 312). The VoIP session may display a user input element, such as a button, icon, or the like, on the approver's machine that the approver uses to approve or reject the request (block 312). The response is displayed to both participants in the VoIP session (block 314). When the VoIP session terminates, the response is transmitted back to the approval service 104 where the approval service 104 records the response that is stored in the directory service 132. The response may also be transmitted back to the approvee and/or the secured resource (block 314).

Applications

The technology described herein has considerable application for various situations. In one or more aspects, the approval service may be implemented as a parental control service that is configured to notify a parent of a request from a child for approval to access a resource. In this situation, the child is the approvee who initiates a request for payment for content from a website, app store, and the like. The child can utilize the approval service for permission to access content that is restricted due to the child's age, ability, or for other reasons.

In one or more other aspects, the approval service may be implemented as an administrative control service that is configured to process a request from a subordinate to a manager or administrator. For example, an employee who needs approval for a new password may utilize the approval service to obtain immediate approval from the manager or administrator. In this scenario, the directory service can store a company's organization chart as the approvee/approver relationship information and search the company's organization chart to determine the appropriate person who can approve the request. Similarly, a new employee may utilize the approval service to obtain access to the company's information technology (IT) resources and other resources to begin work. The applications for the approval service are endless and not limited to any particular scenario.

Technical Effect

Aspects of the subject matter disclosed herein pertain to the technical problem of providing a secure means to request approval for a secured resource that allows the party seeking approval to interact with the approver with a real-time image or video transmission. The technical feature associated with addressing this problem involves an approval service that automatically facilitates the real-time approval between an approvee and its approvers in a central service that services multiple requests for different resources. The approval service utilizes real-time data, such as a real-time image or a video teleconference session, which provides the approver with a form of authentication that ensures that the approval request is genuinely from the approvee. The inclusion of the GPS coordinates along with the real-time image provides an additional form of authentication. The video teleconference session enables the approvee and approver to interact in real-time with each other providing a more secure transaction.

Exemplary Operating Environment

Attention now turns to a discussion of an exemplary operating embodiment. In FIG. 1, there is shown an exemplary operating environment where the approval service 104 operates as a cloud or networked service. In this operating environment, the approval service 104 is composed of several distinct services 130, 132, 134, 136, 138, 140 where each service may be implemented in a separate computing device that is communicatively coupled to other services through network 141. It should be noted that the operating environment is not constrained to separate computing devices for each service and that any number of computing devices and combinations thereof may be utilized.

In this aspect, a service is a component of an application that provides services to other components over a network. The approvee machine 102 communicates with the approval service 106 through a first network 108 and the approval machine 106 communicates with the approval service though a second network 138.

The networks 108, 138, 141 may be configured as an ad hoc network, an intranet, an extranet, a virtual private network (VPN), a local area network (LAN), a wireless LAN (WLAN), a wide area network (WAN), a wireless WAN (WWAN), a metropolitan network (MAN), the Internet, a portions of the Public Switched Telephone Network (PSTN), plain old telephone service (POTS) network, a wireless network, a WiFi® network, or any other type of network or combination of networks.

The networks 108, 138, 141 may employ a variety of wired and/or wireless communication protocols and/or technologies. Various generations of different communication protocols and/or technologies that may be employed by a network may include, without limitation, Global System for Mobile Communication (GSM), General Packet Radio Services (GPRS), Enhanced Data GSM Environment (EDGE), Code Division Multiple Access (CDMA), Wideband Code Division Multiple Access (W-CDMA), Code Division Multiple Access 2000, (CDMA-2000), High Speed Downlink Packet Access (HSDPA), Long Term Evolution (LTE), Universal Mobile Telecommunications System (UMTS), Evolution-Data Optimized (Ev-DO), Worldwide Interoperability for Microwave Access (WiMax), Time Division Multiple Access (TDMA), Orthogonal Frequency Division Multiplexing (OFDM), Ultra Wide Band (UWB), Wireless Application Protocol (WAP), User Datagram Protocol (UDP), Transmission Control Protocol/Internet Protocol (TCP/IP), any portion of the Open Systems Interconnection (OSI) model protocols, Session Initiated Protocol/Real-Time Transport Protocol (SIP/RTP), Short Message Service (SMS), Multimedia Messaging Service (MMS), or any other communication protocols and/or technologies.

The computing devices utilized in the approval service may include, without limitation, a mobile device, a personal digital assistant, a mobile computing device, a smart phone, a cellular telephone, a handheld computer, a server, a server array or server farm, a web server, a network server, a blade server, an Internet server, a work station, a mini-computer, a mainframe computer, a supercomputer, a network appliance, a web appliance, a distributed computing system, multiprocessor systems, or combination thereof.

In one aspect, the approver machine 142 is a mobile computing device such as a cellular phone, smart phone, tablet, personal display assistant (PDA), and the like. The mobile computing device may include at least one processor 144, such as a central processing unit (CPU), hardware microcontroller (e.g., System On A Chip (SOC)), and/or multi-processors, communicatively coupled to a memory 146 via a bus 145.

The approver machine 142 may include a cellular transceiver 152 configured to receive and transmit cellular data, a communications interface 149, and a video interface 153. The mobile computing device may include, although not shown in FIG. 1, a power supply, a storage device, an input/output interface. one or more cameras, a touch interface, an audio interface, a display, a keyboard, a pointing device, and the like. The mobile computing device may communicate with a base stations (not shown) or directly with another computing device. The cameras may be used to capture image and/or image content or data for transmission during a communication session.

The communications interface 149 includes circuitry for coupling the mobile computing device to one or more networks that are configured to use, without limitation, protocols and technologies that implement any portion of the OSI model, GSM, CDMA, time division multiple access (TDMA), UDP, TCP/IP, SMS, MMS, GPRS, WAP, UWB, WiMax, SIP/RTP, EDGE, WCDMA, LTE, UMTS, OFDM, or any of a variety of other wireless communication protocols. The communications interface 149 can be a transceiver or network interface card.

The video interface 153 may be configured to capture video images, such as a still photo, a video segment, and the like. The video interface 153 may be coupled to a digital video camera, a web camera, and the like. The video interface 153 may comprise a lens, an image sensor, and the like.

The memory 146 may be any non-transitory computer-readable storage media that may store executable procedures, applications, and data. The computer-readable storage media does not pertain to propagated signals, such as modulated data signals transmitted through a carrier wave. It may be any type of non-transitory memory device (e.g., random access memory, read-only memory, etc.), magnetic storage, volatile storage, non-volatile storage, optical storage, DVD, CD, floppy disk drive, etc. that does not pertain to propagated signals, such as modulated data signals transmitted through a carrier wave. The memory 146 may also include one or more external storage devices or remotely located storage devices that do not pertain to propagated signals, such as modulated data signals transmitted through a carrier wave.

The approvee machine 102 may be implemented as a computing device, such as, a mobile device, a personal digital assistant, a mobile computing device, a smart phone, a cellular telephone, a handheld computer, a server, a server array or server farm, a web server, a network server, a blade server, an Internet server, a work station, a mini-computer, a mainframe computer, a supercomputer, a network appliance, a web appliance, a distributed computing system, multiprocessor systems, or combination thereof.

The approvee machine 102 may include at least one processor 110, a camera 112, a satellite transceiver 114, a video interface 115, a memory 116, and a communications interface 117. The approvee machine 102 may also include, although not shown in FIG. 1, a power supply, a storage device, an input/output interface, a touch interface, an audio interface, a display, a keyboard, a pointing device and the like.

The satellite transceiver 114 can determine the physical coordinates of the mobile computing device on the surface of the Earth through signals supplied by the satellite 110 which represents a location in longitude and latitude values, otherwise known as geo-location data. The satellite transceiver 114 can employ other geo-location mechanisms, such as without limitation, triangulation, Time Different (E-OTD), Cell Identifier (CI), Service Area Identifier (SAD, Enhanced Timing Advance (ETA), Base Station Subsystem (BSS), and the like, to further determine the physical location of the mobile computing device on the surface of the Earth. In other aspects, the physical location of the mobile computing device may be determined through other components that utilize Media Access Control (MAC) address, IP address, and the like.

The communications interface 117 includes circuitry for coupling the mobile computing device to one or more networks that are configured to use, without limitation, protocols and technologies that implement any portion of the OSI model, GSM, CDMA, time division multiple access (TDMA), UDP, TCP/IP, SMS, MMS, GPRS, WAP, UWB, WiMax, SIP/RTP, EDGE, WCDMA, LTE, UMTS, OFDM, or any of a variety of other wireless communication protocols. The communications interface 117 can be a transceiver or network interface card.

The video interface 115 may be configured to capture video images, such as a still photo, a video segment, and the like. The video interface 115 may be coupled to a digital video camera, a web camera, and the like. The video interface 115 may comprise a lens, an image sensor, and the like.

The memory 116 may be any non-transitory computer-readable storage media that may store executable procedures, applications, and data. The computer-readable storage media does not pertain to propagated signals, such as modulated data signals transmitted through a carrier wave. It may be any type of non-transitory memory device (e.g., random access memory, read-only memory, etc.), magnetic storage, volatile storage, non-volatile storage, optical storage, DVD, CD, floppy disk drive, etc. that does not pertain to propagated signals, such as modulated data signals transmitted through a carrier wave. The memory 116 may also include one or more external storage devices or remotely located storage devices that do not pertain to propagated signals, such as modulated data signals transmitted through a carrier wave.

Although the subject matter has been described in language specific to structural features and/or methodological acts, it is to be understood that the subject matter defined in the appended claims is not necessarily limited to the specific features or acts described above. Rather, the specific features and acts described above are disclosed as example forms of implementing the claims.

It should be noted that various modifications can be made to the technology described herein. For example, the approval service can be configured to provide both real-time data to an approver. In this aspect, the approval service can be configured to send the secure package to an approver through a push notification. When the approver receives the push notification which displays the photo and location of the approvee to the approver, the approver can choose to initiate a video communication session with the approvee or decline the invitation to initiate the video communication session. Once the video communication session is initiated, the approvee engages with the approvee interactively in the video communication session to seek approval. The approver can grant or deny the requested approval.

By way of another example, the approval service may utilize a short message service to transmit the secured package to the approver and/or to notify the approver of an incoming video communication session. Furthermore, the approver can initiate the approval relationships rather than the approvee.

What is claimed:

1. A system, comprising:
at least one processor and a memory;
an approval service configured to receive a request to approve access to a secured resource for an approvee, the request including real-time data generated at a time the approvee makes the request, the request including a real-time video image of the approvee and geo-coordinates of a location in which the approvee makes the request, wherein the approval service determines an approver for the request, sends the real-time data to the approver and obtains a response to the request.

2. The system of claim 1, wherein the request is formatted as an encrypted message.

3. The system of claim 1, wherein the approval service provides an application for use on a computing device associated with the approvee, the application having a capability to obtain the geo-coordinates and real-time image of the approvee.

4. The system of claim 1, wherein the approval service provides an application for use on a computing device associated with the approver, the application having a capability to display the real-time video image and the geo-coordinates.

5. The system of claim 4, wherein the application has the capability to transmit the response from the computing device associated with the approver to the approval service.

6. The system of claim 1, wherein the approval service verifies a source of the request by verifying an approvee associated with the request through a token generated by a secure token service.

7. The system of claim 1, wherein the approval service transmits the request to the approver through a push notification service or a short message service.

8. A system, comprising:
a consent service that receives a verified request, the request seeking approval from an approver for an approvee to access a secured resource; and
a Voice over IP (VoIP) service that connects a verified approvee with a corresponding approver with a video teleconference in which the approvee requests approval from the approver when the verified request indicates a video teleconference;
wherein the consent service obtains a real-time IP address of a computing device associated with the approvee at a time when the request is made by the approvee and obtains a real-time IP address of the mobile computing device associated with the approver at a time when the consent service receives the request,
wherein the VoIP establishes the video teleconference using the real-time IP address of the mobile computing device and the real-time IP address of the computing device of the approvee,
wherein the consent service transmits a response from the approver to the request to the secured resource and/or approvee.

9. The system of claim 8, further comprising a secure token service that verifies an identity of an approvee and/or approver through a secured token.

10. The system of claim 8, wherein the consent service receives a secure package including a video image of the approvee at a time when the verified request is made and geo-coordinates representing a location of the approvee when the verified request is made.

11. The system of claim 10, further comprising a push notification service that configures a dedicated channel to push notification of the secured package to a mobile computing device associated with the approver.

12. The system of claim 8, wherein the approvee is a child and the approver is a parent of the child.

13. The system of claim 8, wherein the approvee is a subordinate and the approver is a manager of the subordinate.

14. The system of claim 8, further comprising a directory service that stores relationship data that relates an approvee with one or more approvers for a secured resource.

15. The system of claim 8, wherein the directory service includes an organization chart and wherein the consent service uses the organization chart to identify an approver to the request.

16. A method performed by a computing device comprising at least one processor, the method comprising:
receiving a request to approve access to a secured resource for an approvee, the request including real-time data generated at a time the approvee makes the request, the real-time data including a secured package or a request for a real-time video communication session, the secured package including a real-time video image of the approvee and geo-coordinates of a location in which the approvee makes the request;
transmitting the secured package to a mobile device associated with the approver when the request includes the secured package;
initiating a real-time video communication session to the mobile device when the request indicates a real-time video communication session;
obtaining a response from the approver to the request; and
transmitting the response to the approvee and/or secured resource.

17. The method of claim 16, further comprising:
establishing a relationship between the approvee and the approver prior to receipt of the request; and
using the relationship to determine the approver for the request.

18. The method of claim 16, wherein the secured package is encrypted.

19. The method of claim 16, wherein the secured package is transmitted to a mobile device of the approver through a push notification service.

20. The method of claim 16, wherein the voice communication session is a video teleconference.
